(19) United States
(12) Patent Application Publication
(10) Pub. No.: US 2020/0115604 A1
(43) Pub. Date: Apr. 16, 2020

(54) Traction Enhancing Composition

(71) Applicant: 11225162 Canada Inc., Sudbury (CA)

(72) Inventor: Sean Patrick, Sudbury (CA)

(21) Appl. No.: 16/591,091

(22) Filed: Oct. 2, 2019

Related U.S. Application Data
(63) Continuation-in-part of application No. 15/393,250, filed on Dec. 29, 2016, now abandoned.

(51) Int. Cl. C09K 3/14; C09D 5/00; C09D 7/45

(52) U.S. Cl. CPC C09K 3/149; C09D 7/45; C09D 5/00

(57) ABSTRACT

A traction enhancing composition that increases traction on all types of footwear and other surfaces is provided. Within a composition suitable for application to the surface of any footwear sole in liquid form, by pouring the composition into the bag supplied, and then placing the footwear into the composition for up to 12 hours. Alternately, by applying to composition to a horizontal surface for approximately one hour. During this time, a nano-technology coating is bonded to the footwear sole that increases the traction properties of the surfaces. Once applied to the footwear, the coating causes the surface of the footwear sole to repel debris. This imparts continued tackiness over extended use, from 1 month to up to 3 months depending on amount of use and friction the surface experiences.

### CROSS-REFERENCES TO RELATED APPLICATIONS

This application claims priority as a continuation-in-part of prior filed U.S. application Ser. No. 15/393,250, filed Dec. 29, 2016, and incorporated the same by reference herein in its entirety.

### FIELD OF THE INVENTION

The invention generally relates to increasing traction on all types of footwear and, golf club grips, motorcycle seats, snow machines, water vehicles, surfboards, work tools, truck trailers, sports equipment, stairs, boats, docks, and floors and more particularly relates to a chemical composition which imparts enhanced traction features on these and other surfaces.

### BACKGROUND OF THE INVENTION

Annual shoe sales revenue was over 68 Billion in 2014. There are literally millions of makes, models and styles of footwear that are slippery and contribute to slips and falls. There are many thousands of indoor and outdoor surfaces and environments that exist where safety is improved with the availability of a surface coating that may be applied to the sole of most footwear and floors, all bathtubs/showers or to any other surface to improve traction and grip. Also, all industries and people have a major safety problem at work and home with the concerns of slip Et fall injuries. Wet or damp floors are only one of the causes of slip and fall accidents within many industries. Clutter, footwear and improper cleaning also cause slip and falls or both employees and building occupants. Slips, trips and falls make up the majority of general industry accidents. According to the U.S. Department of Labor's Occupational Safety Et Health Administration (OSHA), slips, trips and falls account for 15 percent of all accidental deaths and are second only to motor vehicles as a cause of fatalities. Slip and fall accidents account for over 300,000 disabling injuries per year in North America. Worker's Compensation and Liability Insurance Rates are increasing on the average of 30% per year. Despite greater awareness of workplace health and safety and a growing concern worldwide, these statistics show a shocking rise in workplace injuries and fatalities in the US. All industries have many hazardous conditions that lead to slip and fall injury. Such as when walking through wet areas, stairs or while using ladders. Smooth hard surfaces may also be slippery when dry. Dust on all floors, ladders, stairs and other surfaces cause slip and fall accidents.

What is needed then is a way to increase the surface friction, and thus traction of a given surface. This surface may be the sole of a shoe or may be bathtub, shower or any other type of surface that is stepped on or gripped. For a shoe, a typical application is for the sole of all shoes, boots, dress shoes, high heel and all other footwear. For other surfaces which typically become slippery and un-safe when cold or wet, including but not limited to surgical gloves, snow machine seats, water sport seats, boards, flooring, shower surfaces, and bathroom floors, the application of a traction enhancing compound is placed on the surface and provided an adequate dwell time in which traction may be enhanced by the action of the compound. Other areas that may be inherently unsafe include entrances/exits to brick and mortar businesses, swimming pools, boat decks and docks. Increasing safety through the introduction of a traction coating can improve safety and limit liability when surfaces become slipper by means of water and/or a decreased temperature. There is a substantial need over a very wide range of applications for coatings which exhibit substantial traction or friction when said surfaces become cold or wet.

Currently there are anti slip products like paint with plastic particles that take 24 hours to dry. However, no one wants to paint their shoes, boots, high heels or paint their indoor staircases. Currently there are specialized work shoes Et boots that have been designed and promoted as offering increased grip and traction in the restaurant industry and others. These do offer more grip than regular boots and shoes, but they fail to provide adequate traction in all indoor/outdoor surfaces because they are made of rubber and rubber becomes slippery went wet or on cold surfaces. As can be seen, there is a need for a composition that enhances grip of surfaces and shoes.

### SUMMARY OF THE INVENTION

The present invention is a composition for providing increased grip and traction to all types' footwear and low traction horizontal surfaces. The present invention solves the slip and fall problem on all types of work boots, shoes, dress shoes, children's shoes, high heels, boots, running and athletic shoes, hiker boots, and all other footwear saving the legal risk and financial loss of companies and increased safety for everyone—no matter where they walk. The composition is also usable on surfaces on which increased traction or grip is desired, including floors, sports equipment and tool handles.

The present invention allows individuals to apply a traction enhancing composition on all footwear and other surfaces to avoid slips and falls and generally increase the friction coefficient of that surface. The present invention is an invisible traction enhancing composition that is odorless and colorless and takes anywhere from 1 hour to 12 hours to increase traction to any footwear or other surface by:
1. adding many nano-technology spikes to the user's footwear sole or other surface; and,
2. eliminating the need or expense of searching and buying expensive footwear that claim to be anti-slip.

In view of the foregoing disadvantages inherent in the known types of friction enhancing strategies, an improved friction enhancing composition may provide a discrete application that meets the following objectives: it is easy to apply to most surfaces, sufficiently increases the coefficient of friction on surfaces upon which it is applied, is inexpensive and may be readily available for any number of individuals. As such, a new and improved friction enhancing composition may comprise a suspension of various acids and bases in a saline carrier in order to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the first step in applying a traction enhancing composition to an item of footwear.

FIG. 2 is a perspective view of the second step in applying a traction enhancing composition to an item of footwear.

FIG. 3 is a perspective view of the third step in applying a traction enhancing composition to an item of footwear.

FIG. 4 is a schematic view of the first stage of the process by which a traction enhancing composition may add traction crystals to a surface, corresponding to an initial stage between FIGS. 1 and 2.

FIG. 5 is a schematic view of the second stage of the process by which a traction enhancing composition may add traction crystals to a surface, corresponding to FIG. 2.

FIG. 6 is a schematic view of the third stage of the process by which a traction enhancing composition may add traction crystals to a surface, corresponding to a stage between FIGS. 2 and 3.

FIG. 7 is a schematic view of the finished surface after the process illustrated in FIGS. 4-6.

### DETAILED DESCRIPTION OF THE PREFERRED EMBODIMENT

With reference now to the drawings, a preferred embodiment of the traction enhancing composition is herein described. It should be noted that the articles “a”, “an”, and “the”, as used in this specification, include plural referents unless the content clearly dictates otherwise.

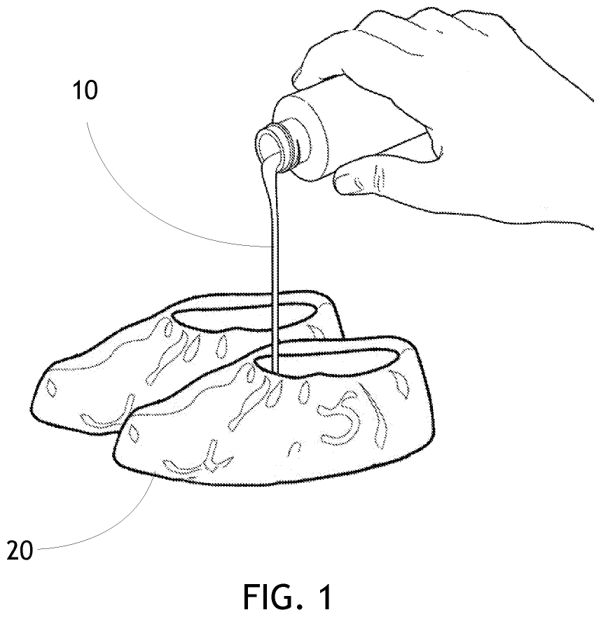

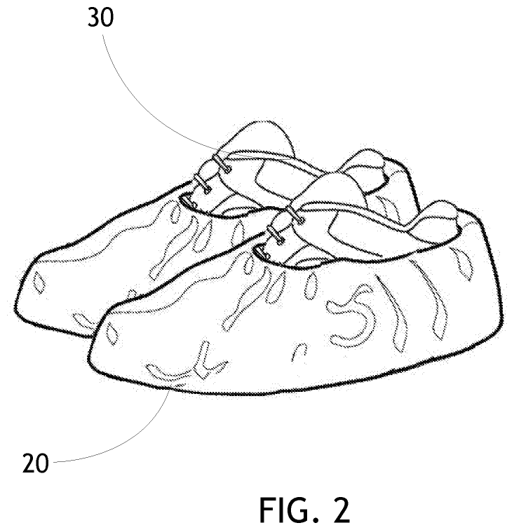

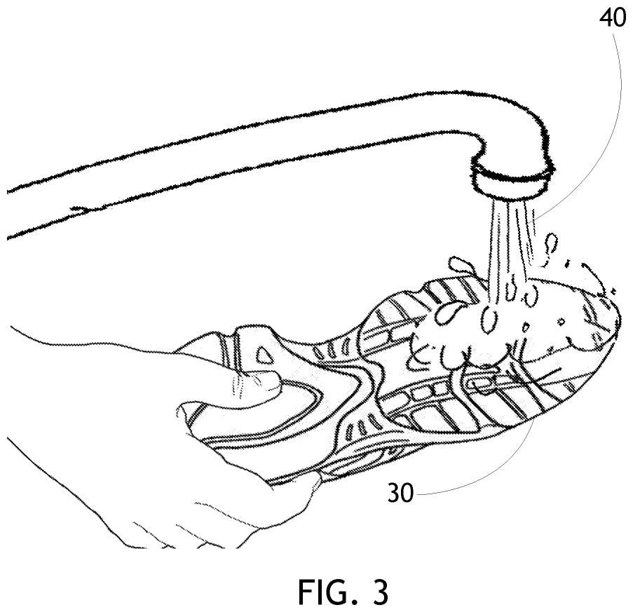

With reference to FIGS. 1 through 3, the initial embodiment of the invention is disclosed, where a composition was used to enhance the traction of a shoe 30. In use, a preparer would first remove a bag 20 from the package and then shake a bottle of the composition 10 and remove the cap, pouring an amount of the composition into the bag 20 and then place their desired pair of footwear 30 into the bag 20.

The user would then wait for the prescribed time of 12 hours before they could remove their footwear. Once the time was up, the user would remove their footwear 30 and then run water 40 over the soles of the footwear for a few seconds to deactivate the composition. A proper formulation of the composition could last between 12 to 3 months under average use.

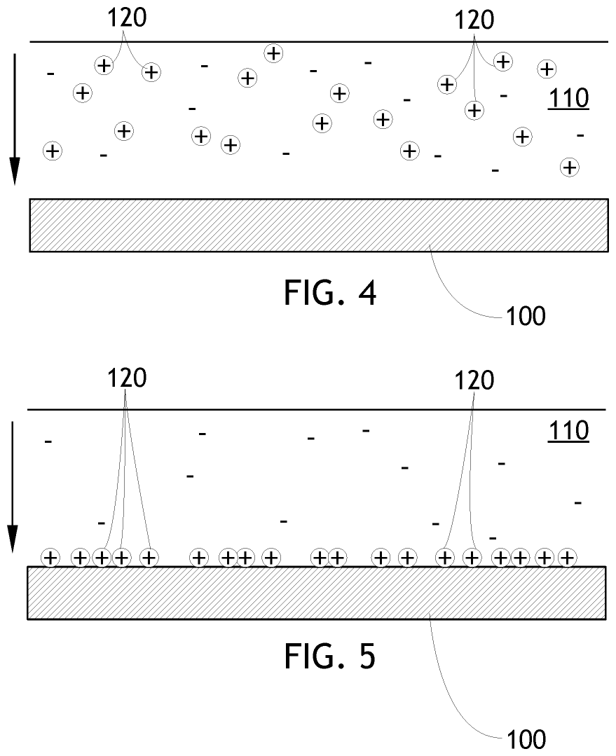

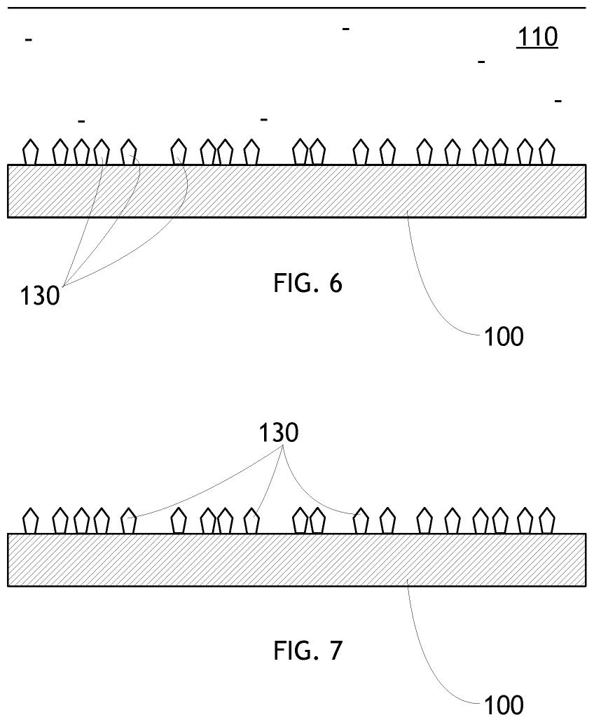

However, the composition may be utilized with other surfaces, with particular emphasis on the surfaces walked upon rather than the soles of the shoes themselves. In applying to a horizontal surface, the dwell time is greatly reduced due to the components of the composition being in a suspension. The process is demonstrated in FIGS. 4-7. The composition is a suspension of at least one acid member in a solution formed of an aqueous carrier, such as water, and at least one activator member in the solution. The composition is first sprayed or otherwise spread onto the surface which is desired to be treated 100 (FIG. 4). The aqueous member and at least one activator present a solution with abundant negative ions 110 and covers the surface 100. The generally positive acid molecules 120 are suspended in the solution 110 and are eventually influenced by gravity to settle on the surface 100 (FIG. 5). Once on the surface, the acids 120 draw activator molecules from the solution 110 and create nano-sized crystals 130 on the surface 100 (FIG. 6). After approximately one hour, the aqueous solution 110 may be rinsed off the surface, leaving the crystalline nano-sized structures, or “nano-spikes” 130 (FIG. 7) and an enhanced traction profile for the surface.

Many different ingredients may be utilized in the composition. The acid may be chosen from any commercially available acids, including but not limited to: Sulfuric Acid, Hydrochloric Acid, Nitrous Acid, Nitric Acid, Carbonic Acid, Oxalic Acid, Acetic Acid, Phosphoric Acid, Phosphorous Acid, Bromic Acid, Iodic Acid, Fluoric Acid, Chromic Acid, Selenic Acid, Boric Acid, Telluric Acid, Tungstic Acid, Xenic Acid, Citric Acid, Formic Acid, Pyroantimonic Acid, Permanganic Acid, Manganic Acid, Antimonic Acid, Silicic Acid, Titanic Acid, Arsenic Acid, Pertechnetic Acid, Dichromic Acid, Ferricyanic Acid, Cyanic Acid, Diuranic Acid, Malonic Acid, Citric Acid, Tartartic Acid, Glutamic Acid, Phthalic Acid, Azelaic Acid, Barbituric Acid, Benzilic Acid, Cinnamic Acid, Fumaric Acid, Glutaric Acid, Gluconic Acid, Hexanoic Acid, Lactic Acid, Malic Acid, Oleic Acid, Folic Acid, Propiolic Acid, Propionic Acid, Rosolic Acid, Stearic Acid, Tannic Acid, Trifluoroacetic Acid, Uric Acid, Ascorbic Acid, Gallic Acid, Acetylsalicylic Acid, and Acetic Acid. Oxalates may also be utilized to provide the acidic component The activator component may be any soluble oxide, chlorite, or fluoride from which the acid may draw structure to form the crystalline nano-spikes. The aqueous solution member serves as a sealant to allow the formation of the nano-spikes 130. Basic solutions (pH>7.0) tend to assist in the dropping of the acids onto the surface, though the acids 120 will drop in any pH level. Solutions of various phosphates and phosphatases in water, such as Ammonium phosphate, Calcium phosphate, Tyrosine phosphatase, Theronine phosphatase, Histidine phosphatase, Dicalcium phosphate, Disodium phosphate, Monosodium phosphate, Potassium phosphate, Sodium hexameta-phosphate, Trisodium phosphate, Sodium tripolyphosphate, Tetrasodium pyrophosphate, and Tripotassium phosphate, will serve as adequate basic modifiers to the solution. Surfactants may also be added to aid in the spread of the composition over a surface. Any non-active surfactant may be used in the composition, with a preference for those that tend to have higher pH values.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A traction enhancing composition comprising:
a. an aqueous solution with at least one activator dissolved within;
b. at least one acid, molecules of which are suspended in the aqueous solution;
wherein, when the composition is applied to a surface, acid molecules will eventually adhere to the surface and combine with activator ions to form crystalline nano-structures on the surface.

2. The traction enhancing compound of claim 1, the at least one activator being chosen from the group of activators consisting of: oxides, fluorides, and chlorates.

3. The traction enhancing composition of claim 1, the at least one acid being selected from the group of acids consisting of: Sulfuric Acid, Hydrochloric Acid, Nitrous Acid, Nitric Acid, Carbonic Acid, Oxalic Acid, Acetic Acid, Phosphoric Acid, Phosphorous Acid, Bromic Acid, Iodic Acid, Fluoric Acid, Chromic Acid, Selenic Acid, Boric Acid, Telluric Acid, Tungstic Acid, Xenic Acid, Citric Acid, Formic Acid, Pyroantimonic Acid, Permanganic Acid, Manganic Acid, Antimonic Acid, Silicic Acid, Titanic Acid, Arsenic Acid, Pertechnetic Acid, Dichromic Acid, Ferricyanic Acid, Cyanic Acid, Diuranic Acid, Malonic Acid, Citric Acid, Tartartic Acid, Glutamic Acid, Phthalic Acid, Azelaic Acid, Barbituric Acid, Benzilic Acid, Cinnamic Acid, Fumaric Acid, Glutaric Acid, Gluconic Acid, Hexanoic Acid, Lactic Acid, Malic Acid, Oleic Acid, Folic Acid, Propiolic Acid, Propionic Acid, Rosolic Acid, Stearic Acid, Tannic Acid, Trifluoroacetic Acid, Uric Acid, Ascorbic Acid, Gallic Acid, Acetylsalicylic Acid, and Acetic Acid.

4. The traction enhancing composition of claim 3, further comprising at least one oxalate as an acid.

5. The traction enhancing composition of claim 1, further comprising at least one oxalate as the acid.

6. The traction enhancing composition of claim 1, the aqueous solution being a basic solution containing at least one base selected from the group of bases consisting of: phosphates and phosphatases.

7. The traction enhancing composition of claim 1, further comprising a surfactant.

8. The traction enhancing compound of claim 7, the at least one activator being chosen from the group of activators consisting of: oxides, fluorides, and chlorates.

9. The traction enhancing composition of claim 7, the at least one acid being selected from the group of acids consisting of: Sulfuric Acid, Hydrochloric Acid, Nitrous Acid, Nitric Acid, Carbonic Acid, Oxalic Acid, Acetic Acid, Phosphoric Acid, Phosphorous Acid, Bromic Acid, Iodic Acid, Fluoric Acid, Chromic Acid, Selenic Acid, Boric Acid, Telluric Acid, Tungstic Acid, Xenic Acid, Citric Acid, Formic Acid, Pyroantimonic Acid, Permanganic Acid, Manganic Acid, Antimonic Acid, Silicic Acid, Titanic Acid, Arsenic Acid, Pertechnetic Acid, Dichromic Acid, Ferricyanic Acid, Cyanic Acid, Diuranic Acid, Malonic Acid, Citric Acid, Tartartic Acid, Glutamic Acid, Phthalic Acid, Azelaic Acid, Barbituric Acid, Benzilic Acid, Cinnamic Acid, Fumaric Acid, Glutaric Acid, Gluconic Acid, Hexanoic Acid, Lactic Acid, Malic Acid, Oleic Acid, Folic Acid, Propiolic Acid, Propionic Acid, Rosolic Acid, Stearic Acid, Tannic Acid, Trifluoroacetic Acid, Uric Acid, Ascorbic Acid, Gallic Acid, Acetylsalicylic Acid, and Acetic Acid.

10. The traction enhancing composition of claim 9, further comprising at least one oxalate as an acid.

11. The traction enhancing composition of claim 7, further comprising at least one oxalate as the acid.

12. The traction enhancing composition of claim 7, the aqueous solution being a basic solution containing at least one base selected from the group of bases consisting of: phosphates and phosphatases.

13. The traction enhancing compound of claim 6, the at least one activator being chosen from the group of activators consisting of: oxides, fluorides, and chlorates.

14. The traction enhancing composition of claim 6, the at least one acid being selected from the group of acids consisting of: Sulfuric Acid, Hydrochloric Acid, Nitrous Acid, Nitric Acid, Carbonic Acid, Oxalic Acid, Acetic Acid, Phosphoric Acid, Phosphorous Acid, Bromic Acid, Iodic Acid, Fluoric Acid, Chromic Acid, Selenic Acid, Boric Acid, Telluric Acid, Tungstic Acid, Xenic Acid, Citric Acid, Formic Acid, Pyroantimonic Acid, Permanganic Acid, Manganic Acid, Antimonic Acid, Silicic Acid, Titanic Acid, Arsenic Acid, Pertechnetic Acid, Dichromic Acid, Ferricyanic Acid, Cyanic Acid, Diuranic Acid, Malonic Acid, Citric Acid, Tartartic Acid, Glutamic Acid, Phthalic Acid, Azelaic Acid, Barbituric Acid, Benzilic Acid, Cinnamic Acid, Fumaric Acid, Glutaric Acid, Gluconic Acid, Hexanoic Acid, Lactic Acid, Malic Acid, Oleic Acid, Folic Acid, Propiolic Acid, Propionic Acid, Rosolic Acid, Stearic Acid, Tannic Acid, Trifluoroacetic Acid, Uric Acid, Ascorbic Acid, Gallic Acid, Acetylsalicylic Acid, and Acetic Acid.

15. The traction enhancing composition of claim 14, further comprising at least one oxalate as an acid.

16. The traction enhancing composition of claim 6, further comprising at least one oxalate as the acid.
